(19) United States
(12) Patent Application Publication
(10) Pub. No.: US 2023/0132227 A1
(43) Pub. Date: Apr. 27, 2023

(54) METHODS AND SYSTEMS FOR FACILITATING IMPROVING SALES ASSOCIATED WITH REAL ESTATE

(71) Applicants: Sunder Jagannathan, Coimbatore (IN); Vivek Agarwal, Faridabad (IN); Hitesh Singla, Gurgaon (IN)

(72) Inventors: Sunder Jagannathan, Coimbatore (IN); Vivek Agarwal, Faridabad (IN); Hitesh Singla, Gurgaon (IN)

(73) Assignee: SY Interiors Pvt. Ltd, New Delhi (IN)

(21) Appl. No.: 17/511,507

(22) Filed: Oct. 26, 2021

(51) Int. Cl. G06Q 10/06; H04L 12/18

(52) U.S. Cl. CPC G06Q 10/06395; G06Q 10/06398; G06Q 10/063114; H04L 12/1831

(57) ABSTRACT

Disclosed herein is a method for facilitating improving sales associated with real estate. Accordingly, the method comprises receiving, using a communication device, sale data associated with sale sessions between clients and agents for conducting sales associated with real estate from a first device, analyzing, using a processing device, the sale data using a machine learning model, determining, using the processing device, sale characteristics associated with the sales of the real estate based on the analyzing, determining, using the processing device, behaviors of the clients corresponding to the sale characteristics based on the analyzing, determining, using the processing device, a correlation between the sale characteristics and the behaviors, generating, using the processing device, a recommendation based on the correlation, transmitting, using the communication device, the recommendation to a device associated with a manager, the agents, and the clients, and storing, using a storage device, the sale data and the recommendation.

### FIELD OF THE INVENTION

Generally, the present disclosure relates to the field of data processing. More specifically, the present disclosure relates to methods and systems for facilitating improving sales associated with real estate.

### BACKGROUND OF THE INVENTION

The field of data processing is technologically important to several industries, business organizations, and/or individuals.

Generally, in the sales and marketing industry, client's words, body language, actions, and facial expressions are crucial in improving sales and closing business deals. Existing techniques for facilitating improving sales associated with real estate are deficient with regard to several aspects. For instance, current technologies do not facilitate monitoring and analyzing of facial expressions, body language, and speech (or words) of the client corresponding to sales pitches delivered by sales agents to the client while making sales and the sales pitches. Moreover, current technologies do not correlate the facial expressions, body language, and speech (or words) of the client with characteristics of the sales pitches and generate recommendations for the sales agents and managers for improving the sales pitches.

Therefore, there is a need for improved methods and systems for facilitating improving sales associated with real estate that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating improving sales associated with real estate, in accordance with some embodiments. Accordingly, the method may include receiving, using a communication device, one or more sale data associated with one or more sale sessions between one or more clients and one or more agents for conducting sales associated with one or more real estate from at least one first device. Further, the method may include analyzing, using a processing device, the one or more sale data using at least one machine learning model. Further, the method may include determining, using the processing device, one or more sale characteristics associated with the sales of the one or more real estate based on the analyzing of the one or more sale data. Further, the method may include determining, using the processing device, one or more behaviors of the one or more clients corresponding to the one or more sale characteristics based on the analyzing of the one or more sale data. Further, the method may include determining, using the processing device, a correlation between the one or more sale characteristics and the one or more behaviors corresponding to the one or more sale characteristics. Further, the method may include generating, using the processing device, at least one recommendation based on the correlation between the one or more sale characteristics and the one or more behaviors. Further, the method may include transmitting, using the communication device, the at least one recommendation to at least one device associated with at least one of at least one manager, the one or more agents, and the one or more clients. Further, the method may include storing, using a storage device, the one or more sale data and the at least one recommendation.

Further disclosed herein is a system for facilitating improving sales associated with real estate, in accordance with some embodiments. Accordingly, the system may include a communication device configured for receiving one or more sale data associated with one or more sale sessions between one or more clients and one or more agents for conducting sales associated with one or more real estate from at least one first device. Further, the communication device may be configured for transmitting at least one recommendation to at least one device associated with at least one of at least one manager, the one or more agents, and the one or more clients. Further, the system may include a processing device communicatively coupled with the communication device. Further, the processing device may be configured for analyzing the one or more sale data using at least one machine learning model. Further, the processing device may be configured for determining one or more sale characteristics associated with the sales of the one or more real estate based on the analyzing of the one or more sale data. Further, the processing device may be configured for determining one or more behaviors of the one or more clients corresponding to the one or more sale characteristics based on the analyzing of the one or more sale data. Further, the processing device may be configured for determining a correlation between the one or more sale characteristics and the one or more behaviors corresponding to the one or more sale characteristics. Further, the processing device may be configured for generating the at least one recommendation based on the correlation between the one or more sale characteristics and the one or more behaviors. Further, the system may include a storage device communicatively coupled with the processing device. Further, the storage device may be configured for storing the one or more sale data and the at least one recommendation.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system for facilitating improving sales associated with real estate, in accordance with some embodiments.

FIG. 3 is a flowchart of a method for facilitating improving sales associated with real estate, in accordance with some embodiments.

FIG. 4 is a flowchart of a method for facilitating improving sales associated with real estate, in accordance with some embodiments.

FIG. 5 is a tabular representation illustrating factors considered for profile score, in accordance with some embodiments.

FIG. 6 is a tabular representation illustrating a degradation formula, in accordance with some embodiments.

FIG. 7 is a tabular representation illustrating listing completeness score, in accordance with some embodiments.

FIG. 8 is a tabular representation illustrating factors for image quantity and tag score, in accordance with some embodiments.

FIG. 9 is a tabular representation illustrating factors for image quantity and tag score, in accordance with some embodiments.

FIG. 10 is a tabular representation illustrating factors for image quantity and tag score, in accordance with some embodiments.

FIG. 11 is a tabular representation illustrating factors for boosting listing score, in accordance with some embodiments.

FIG. 12 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating improving sales associated with real estate, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor, etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes methods and systems for facilitating improving sales associated with real estate. Further, the disclosed system may be configured for scoring and ranking different parameters filled by brokers against their profile & property listings. Further, the disclosed system may be configured for awarding points on actionable parameters and using the points to serve users ensuring they not only get the required listing/agent but also of the utmost quality.

Further, the disclosed system may be configured for generating scores associated with agents and property listings based on scoring parameters. Further, agent scoring associated with the agents may be based on profile along with qualifications, service quality (such as call Discussion and recorded quality and site visit quality), transactions, and platform activities. Further, the disclosed system may include a sales-based video and voice calling platform that is tracking both the salesperson and the customers. Further, the disclosed system may record every sales call, and it is then processed by the server which also has the data of the transaction and closures. Based on the success and failure of closures, the analytics on the cloud takes place to improve the efficiency of the overall sales. Further, call recording is converted from speech to text. Further, the disclosed system may be configured for text scanning through AI to find persuasive words and inflection points from voice processing. Further, the disclosed system may be configured for mapping the timing of words and facial expressions, pupil, and customer reactions. Further, the disclosed system may be configured for tracking parameters such as facial expressions, pupil reactions, speech, inflection points in the speech, chat information, duration of the calls, quality of the call, direct feedback received from a form of the customer post-call. Further, the disclosed system may be configured for performing post-call data analytics that may be associated with customer follow-ups, closure—yes or no, revenue from the closure, and time is taken for closure. Further, the disclosed system may be configured for real estate virtual showcasing. Further, the disclosed system may be configured for pixel tracking of mouse movements. Further, the disclosed system may be configured for tracking clicks in the experience. Further, the disclosed system may be configured for providing video, voice, and 3D experience in the center (Virtual showcasing platform). Further, the disclosed system may be configured for opening up brochures, floorplans, and time spent on each of these collaterals, and expressions recognition of the customer during the same. Further, questions asked by customers are analyzed and updated for agents to improve their pitches. Further, the disclosed system may be configured for converting customers to digital booking—getting to understand their feedback post-call on the sales agent and the property being showcased. Further, the path of the virtual showcasing may include the travel path of virtual site visits from the entrance. Further, real estate virtual showcasing may be associated with time spent in each room or image experience.

Further, the disclosed system may be configured for performing post-call recording analysis. Further, the disclosed system may be configured for creating reports for both sales agents and managers to get recommendations based on post-call recording analysis. Further, a transcript of the call gets recorded, highlighting the keywords, and frequency. Further, the post-call recording analysis may be associated with a model to analyze. Further, the timing of the call from multiple calls done by agents is analyzed to predict the best time to call during the day, the average time to be spoken, and most effective keywords and transcripts, pitch and voice tone to be used, how sales agent is dressed on a video call. Further, the disclosed system may be configured for generating reports suggesting recommendations for sales agents and managers. Further, the report may include a post-call report stating the above parameters. Further, the report may include the improvement and efficiency score of the sales agent.

Further, a listing may include listing completeness score, image uniqueness, image quantity+distribution, price relevance, and boosting parameters (Preferred and verified).

For agent scoring, the disclosed system may consider a mix of parameters that stay constant with a profile along with dynamic factors that change based on the agent's activity with clients and dealing with our platform. Further, the disclosed system may be configured for scoring each factor on 100, For static ones, it will be direct. For the dynamic ones, the disclosed system may award 100 points to the highest scorer and normalize the rest of the city users based on that score.

For Service quality, the disclosed system may be configured for taking the average rating of the user which will be an average of reviews received by the user along with ratings received on activities (Site visit, call, and meeting with a client). All the qualified agents for this parameter should have a minimum of 10 unique ratings. Further, score=Average Rating X 20.

Further, the disclosed system may be configured for taking the transaction on count, value, and recency. Further, the highest transactions will be awarded 100 and the rest of that city users will be normalized about that only.

Total Points=Sum of all the transaction points.

Rental Transaction=2 Points

Resale Transaction=10 Points

Further, for platform activities, the disclosed system may be configured for taking the active listing count and lead activity percentage of the broker as an active broker should perform on both parameters to stay relevant. Further, listing count and activity carry a 40 and 60% weightage respectively.

For Listings, the disclosed system may be calculated based on active listing count along with recency factors, which are as follows, 2X Listing Count for listings posted in the last 7 days, 10% weekly reduction after that. Further, the highest score on that city may be awarded 40 and the rest of the users will be normalized on it.

Further, activity percentage may be the percentage of activity done on leads within 13 working hours. Further, for this one, the disclosed system may multiply the average by 12.

Further, for listing scoring, the disclosed system may be configured for putting up a mix of dynamic parameters and some constants that come up in a listing.

Further, the listing completeness score may be rated out of 100 and may have a score against the filled parameters of that listing. Further, image uniqueness may be rated out of 100 and may carry the unique image percentage as a uniqueness score.

Further, price relevance signifies how relevant or realistic is the price of that particular listing, most brokers try to list at a lower price to attract customers. So, if the price of a listing lies in the average bracket then we'll straightaway award 100 else 20% reduction based on the deviation. Apart from these, the disclosed system may be associated with boosting parameters for listing that may include verified listing, featured listing, and listing by a preferred partner.

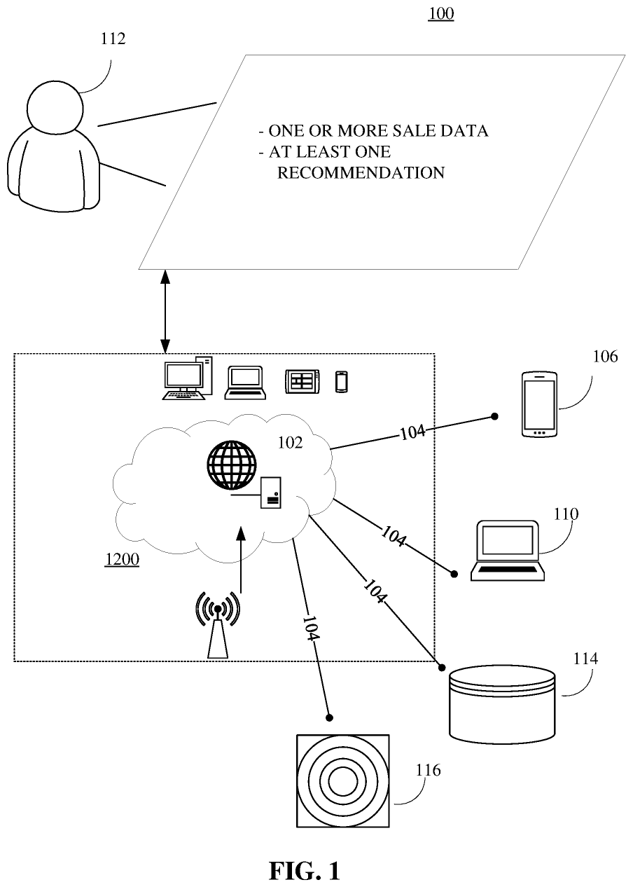

FIG. 1 is an illustration of an online platform 100 consistent with various embodiments of the present disclosure. By way of non-limiting example, the online platform 100 to facilitate improving sales associated with real estate may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 1200.

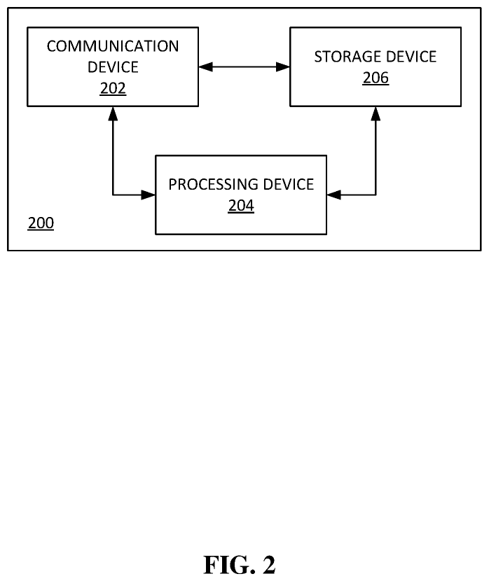

FIG. 2 is a block diagram of a system 200 for facilitating improving sales associated with real estate, in accordance with some embodiments. Accordingly, the system 200 may include a communication device 202 configured for receiving one or more sale data associated with one or more sale sessions between one or more clients and one or more agents for conducting sales associated with one or more real estate from at least one first device. Further, the communication device 202 may be configured for transmitting at least one recommendation to at least one device associated with at least one of at least one manager, the one or more agents, and the one or more clients.

Further, the system 200 may include a processing device 204 communicatively coupled with the communication device 202. Further, the processing device 204 may be configured for analyzing the one or more sale data using at least one machine learning model. Further, the processing device 204 may be configured for determining one or more sale characteristics associated with the sales of the one or more real estate based on the analyzing of the one or more sale data. Further, the processing device 204 may be configured for determining one or more behaviors of the one or more clients corresponding to the one or more sale characteristics based on the analyzing of the one or more sale data. Further, the processing device 204 may be configured for determining a correlation between the one or more sale characteristics and the one or more behaviors corresponding to the one or more sale characteristics. Further, the processing device 204 may be configured for generating the at least one recommendation based on the correlation between the one or more sale characteristics and the one or more behaviors. Further, the at least one recommendation improves the conducting of the sales associated with the one or more real estate.

Further, the system 200 may include a storage device 206 communicatively coupled with the processing device 204. Further, the storage device 206 may be configured for storing the one or more sale data and the at least one recommendation.

Further, in some embodiments, the one or more sale data may include one or more transaction data associated with one or more transactions of the one or more real estate. Further, the analyzing of the one or more sale data may include analyzing the one or more transaction data. Further, the one or more sale characteristics may include one or more transaction characteristics of the one or more transactions. Further, the determining of the one or more sale characteristics may include determining the one or more transaction characteristics. Further, the one or more behaviors may include one or more transaction results of the one or more transactions. Further, the determining of the one or more behaviors may include determining the one or more transaction results of the one or more transactions corresponding to the one or more transactions characteristics. Further, the determining of the correlation between the one or more sale characteristics and the one or more behaviors may include determining the correlation between the one or more transaction characteristics and the one or more transaction results. Further, the generating of the at least one recommendation may be based on the correlation between the one or more transaction characteristics and the one or more transaction results.

Further, in some embodiments, the one or more sale data may include one or more sale pitches delivered by the one or more agents in the one or more sale sessions. Further, the analyzing of the one or more sale data may include analyzing the one or more sale pitches. Further, the one or more sale characteristics may include one or more agent characteristics of the one or more agents. Further, the determining of the one or more sale characteristics may include determining the one or more agent characteristics associated with the one or more agents. Further, the determining of the correlation between the one or more sale characteristics and the one or more behaviors may include determining the correlation between the one or more agent characteristics and the one or more behaviors. Further, the generating of the at least one recommendation may be based on the correlation between the one or more agent characteristics and the one or more behaviors. Further, the generating of the at least one recommendation may include generating the at least one recommendation in real-time during the one or more sale sessions.

Further, in some embodiments, the one or more sale data may include one or more responses provided by the one or more clients corresponding to the one or more sale pitches in the one or more sale sessions. Further, the analyzing of the one or more sale data may include analyzing the one or more responses. Further, the one or more behaviors may include one or more reactions of the one or more clients. Further, the determining of the one or more behaviors may include determining the one or more reactions of the one or more clients corresponding to the one or more agent characteristics. Further, the determining of the correlation between the one or more agent characteristics and the one or more behaviors may include determining the correlation between the one or more agent characteristics and the one or more reactions. Further, the generating of the at least one recommendation may be based on the correlation between the one or more agent characteristics and the one or more reactions.

Further, in some embodiments, the one or more sale pitches may include at least one of one or more agent voices, one or more agent videos, and one or more agent movements of the one or more agents. Further, the analyzing of the one or more sale pitches may include performing at least one of a voice analysis, a video analysis, and a motion analysis of at least one of the one or more agent voices, the one or more agent videos, and the one or more agent movements. Further, the determining of the one or more agent characteristics may be based on the performing of at least one of the voice analysis, the video analysis, and the motion analysis.

Further, in some embodiments, the one or more agent characteristics may include one or more appearances of the one or more agents. Further, the determining of the one or more agent characteristics may include determining the one or more appearances of the one or more agents. Further, the determining of the one or more appearances may be based on the performing of the video analysis.

Further, in some embodiments, the processing device 204 may be configured for converting the one or more agent voices into one or more agent speeches using at least one natural language processing model based on the performing of the voice analysis of the one or more agent voices. Further, the one or more agent characteristics may include one or more keywords present in the one or more agent speeches. Further, the determining of the one or more agent characteristics may include determining the one or more keywords present in the one or more agent speeches. Further, the determining of the one or more keywords may be based on the converting of the one or more agent voices into the one or more agent speeches.

Further, in some embodiments, the one or more agent characteristics may include one or more speech characteristics of the one or more agent speeches. Further, the determining of the one or more agent characteristics may include determining the one or more speech characteristics of the one or more agent speeches. Further, the determining of the one or more speech characteristics may be based on the converting of the one or more agent voices into the one or more agent speeches.

Further, in some embodiments, the one or more sale characteristics may include one or more session characteristics associated with the one or more sale sessions. Further, the determining of the one or more sale characteristics may include determining the one or more session characteristics associated with the one or more sale sessions. Further, the determining of the correlation between the one or more sale characteristics and the one or more behaviors may include determining the correlation between the one or more session characteristics and the one or more behaviors. Further, the generating of the at least one recommendation may be based on the correlation between the one or more session characteristics and the one or more behaviors.

Further, in some embodiments, the storage device 206 may be configured for retrieving one or more feedbacks provided by the one or more clients after the one or more sale sessions. Further, the processing device 204 may be configured for analyzing the one or more feedbacks. Further, the determining of the one or more behaviors of the one or more clients may be based on the analyzing of the one or more feedbacks.

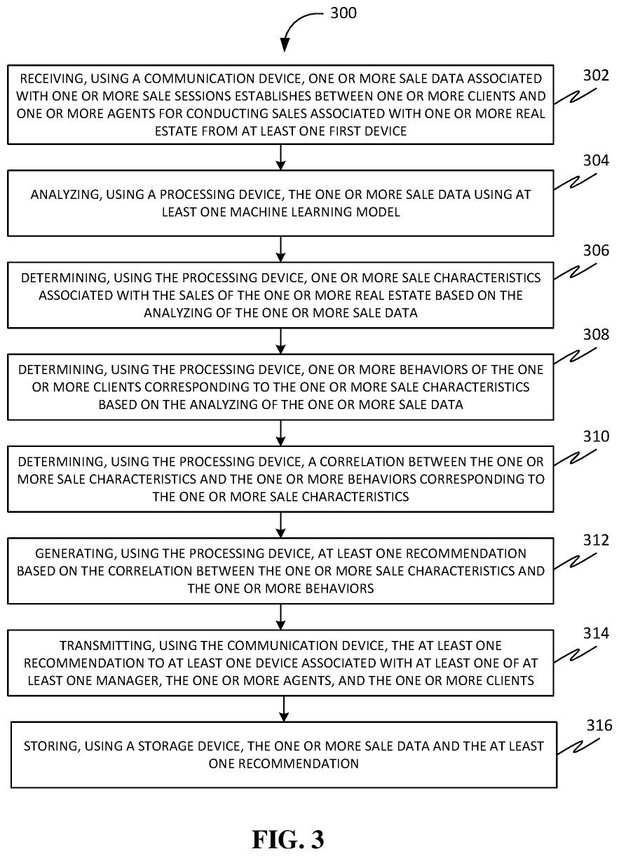

FIG. 3 is a flowchart of a method 300 for facilitating improving sales associated with real estate, in accordance with some embodiments. Accordingly, at 302, the method 300 may include receiving, using a communication device (such as the communication device 202), one or more sale data associated with one or more sale sessions between one or more clients and one or more agents for conducting sales associated with one or more real estate from at least one first device. Further, the one or more sale data may include any data associated with the sales of the one or more real estate. Further, the one or more clients and the one or more agents interact during the one or more sale sessions. Further, the one or more clients may include an individual, an institution, and an organization, etc. interested in purchasing the one or more real estate. Further, the one or more agents may include an individual making the sales of the one or more real estate to the one or more clients. Further, the one or more real estate may be real properties. Further, the real properties may include land and attachments associated with the lands. Further, the attachments may include buildings, plants, equipment, etc.

Further, at 304, the method 300 may include analyzing, using a processing device (such as the processing device 204), the one or more sale data using at least one machine learning model.

Further, at 306, the method 300 may include determining, using the processing device, one or more sale characteristics associated with the sales of the one or more real estate based on the analyzing of the one or more sale data. Further, the one or more sale characteristics may include a duration of the one or more sale sessions, a quality of the one or more sale sessions, a timing of the one or more sale sessions, a type of the one or more sale sessions, a success of closures for the one or more real estate, a failure of closures for the one or more real estate, a state of transaction of the one or more real estate, a sale pitch for the one or more real estate, a revenue generated from the closures of the one or more real estate, a time taken for the closures of the one or more real estate, a number of follow-ups requisition from the one or more clients, etc.

Further, at 308, the method 300 may include determining, using the processing device, one or more behaviors of the one or more clients corresponding to the one or more sale characteristics based on the analyzing of the one or more sale data. Further, the one or more behaviors may include facial expressions, pupil reactions, questions, responses, types of transactions, gestures, etc.

Further, at 310, the method 300 may include determining, using the processing device, a correlation between the one or more sale characteristics and the one or more behaviors corresponding to the one or more sale characteristics. Further, the one or more sale characteristics and the one or more behaviors may be correlated through the correlation.

Further, at 312, the method 300 may include generating, using the processing device, at least one recommendation based on the correlation between the one or more sale characteristics and the one or more behaviors. Further, the at least one recommendation may include a suggestion, a requirement, an improvement, etc. for the conducting of the sales. Further, the at least one recommendation improves the conducting of the sales associated with the one or more real estate.

Further, at 314, the method 300 may include transmitting, using the communication device, the at least one recommendation to at least one device associated with at least one of at least one manager, the one or more agents, and the one or more clients. Further, the at least manager may include an individual that manages the one or more agents and the sales conducted by the one or more agents. Further, the at least one device may include a smartphone, a tablet, a desktop, a laptop, a smartwatch, etc.

Further, at 316, the method 300 may include storing, using a storage device (such as the storage device 206), the one or more sale data and the at least one recommendation.

Further, in some embodiments, the one or more sale data may include one or more transaction data associated with one or more transactions of the one or more real estate. Further, the analyzing of the one or more sale data may include analyzing the one or more transaction data. Further, the one or more sale characteristics may include one or more transaction characteristics of the one or more transactions. Further, the one or more transaction characteristics may include a state of transaction of the one or more real estate, a type of transaction of the one or more real estate. Further, the determining of the one or more sale characteristics may include determining the one or more transaction characteristics. Further, the one or more behaviors may include one or more transaction results of the one or more transactions. Further, the one or more transaction results may include a result of the one or more transactions. Further, the determining of the one or more behaviors may include determining the one or more transaction results of the one or more transactions corresponding to the one or more transactions characteristics. Further, the determining of the correlation between the one or more sale characteristics and the one or more behaviors may include determining the correlation between the one or more transaction characteristics and the one or more transaction results. Further, the generating of the at least one recommendation may be based on the correlation between the one or more transaction characteristics and the one or more transaction results.

Further, in some embodiments, the one or more sale data may include one or more sale pitches delivered by the one or more agents in the one or more sale sessions. Further, the one or more sale pitches may include an agent voice, an agent video, an agent movement, etc. Further, the analyzing of the one or more sale data may include analyzing the one or more sale pitches. Further, the one or more sale characteristics may include one or more agent characteristics of the one or more agents. Further, the one or more agent characteristics may include a voice tone of the agent voice, a usage of keywords in the one or more sale pitches, a frequency of the keywords, a timing of the keywords, an inflection point, a tone of the agent voice, an appearance of the one or more agents, a presentation of the one or more agents, a manner of the one or more agents, etc. Further, the determining of the one or more sale characteristics may include determining the one or more agent characteristics associated with the one or more agents. Further, the determining of the correlation between the one or more sale characteristics and the one or more behaviors may include determining the correlation between the one or more agent characteristics and the one or more behaviors. Further, the generating of the at least one recommendation may be based on the correlation between the one or more agent characteristics and the one or more behaviors. Further, the generating of the at least one recommendation may include generating the at least one recommendation in real-time during the one or more sale sessions.

Further, in some embodiments, the one or more sale data may include one or more responses provided by the one or more clients corresponding to the one or more sale pitches in the one or more sale sessions. Further, the one or more responses may include a client voice, a client video, a client movement, etc. Further, the analyzing of the one or more sale data may include analyzing the one or more responses. Further, the one or more behaviors may include one or more reactions of the one or more clients. Further, the one or more reactions may include facial reactions, pupil reaction, eye movements, hand movements, etc. Further, the determining of the one or more behaviors may include determining the one or more reactions of the one or more clients corresponding to the one or more agent characteristics. Further, the determining of the correlation between the one or more agent characteristics and the one or more behaviors may include determining the correlation between the one or more agent characteristics and the one or more reactions. Further, the generating of the at least one recommendation may be based on the correlation between the one or more agent characteristics and the one or more reactions.

Further, in some embodiments, the one or more sale pitches may include at least one of one or more agent voices, one or more agent videos, and one or more agent movements of the one or more agents. Further, the analyzing of the one or more sale pitches may include performing at least one of a voice analysis, a video analysis, and a motion analysis of at least one of the one or more agent voices, the one or more agent videos, and the one or more agent movements. Further, the determining of the one or more agent characteristics may be based on the performing of at least one of the voice analysis, the video analysis, and the motion analysis.

Further, in some embodiments, the one or more agent characteristics may include one or more appearances of the one or more agents. Further, the determining of the one or more agent characteristics may include determining the one or more appearances of the one or more agents. Further, the determining of the one or more appearances may be based on the performing of the video analysis.

Further, in some embodiments, the method 300 may include converting, using the processing device, the one or more agent voices into one or more agent speeches using at least one natural language processing model based on the performing of the voice analysis of the one or more agent voices. Further, the one or more agent characteristics may include one or more keywords present in the one or more agent speeches. Further, the one or more keywords may include affordable, renowned builder, growing community, trusted community, fast growing, very limited view, lake facing, etc. Further, the determining of the one or more agent characteristics may include determining the one or more keywords present in the one or more agent speeches. Further, the determining of the one or more keywords may be based on the converting of the one or more agent voices into the one or more agent speeches.

Further, in some embodiments, the one or more agent characteristics may include one or more speech characteristics of the one or more agent speeches. Further, the one or more speech characteristics articulation, pronunciation, speech disfluency, speech pauses, speech pitch, speech rate, speech rhythm, word timing, etc. Further, the determining of the one or more agent characteristics may include determining the one or more speech characteristics of the one or more agent speeches. Further, the determining of the one or more speech characteristics may be based on the converting of the one or more agent voices into the one or more agent speeches.

Further, in some embodiments, the one or more sale characteristics may include one or more session characteristics associated with the one or more sale sessions. Further, the one or more session characteristics may include a session time, a session duration, a session frequency, etc. Further, the determining of the one or more sale characteristics may include determining the one or more session characteristics associated with the one or more sale sessions. Further, the determining of the correlation between the one or more sale characteristics and the one or more behaviors may include determining the correlation between the one or more session characteristics and the one or more behaviors. Further, the generating of the at least one recommendation may be further based on the correlation between the one or more session characteristics and the one or more behaviors.

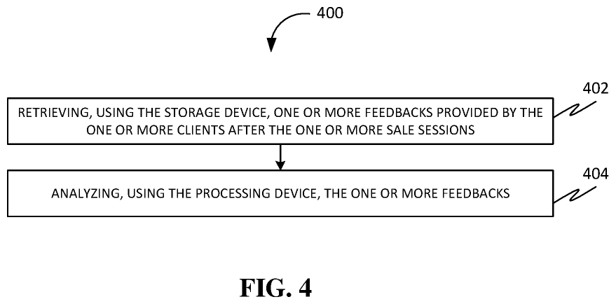

FIG. 4 is a flowchart of a method 400 for facilitating improving sales associated with real estate, in accordance with some embodiments. Accordingly, at 402, the method 400 may include retrieving, using the storage device, one or more feedbacks provided by the one or more clients after the one or more sale sessions.

Further, at 404, the method 400 may include analyzing, using the processing device, the one or more feedbacks. Further, the determining of the one or more behaviors of the one or more clients may be based on the analyzing of the one or more feedbacks.

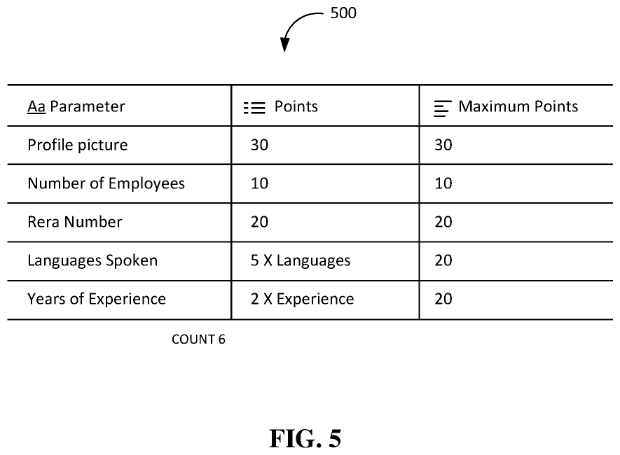

FIG. 5 is a tabular representation 500 illustrating factors considered for profile score, in accordance with some embodiments.

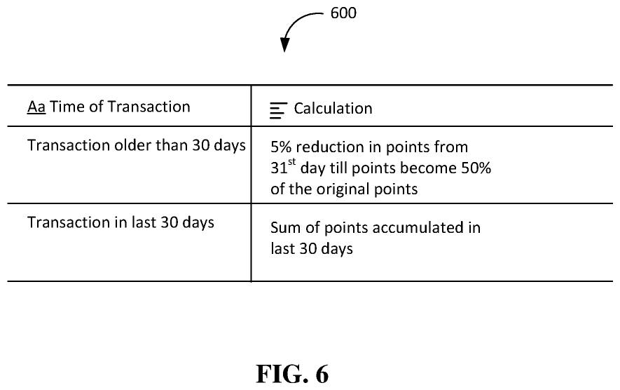

FIG. 6 is a tabular representation 600 illustrating a degradation formula, in accordance with some embodiments.

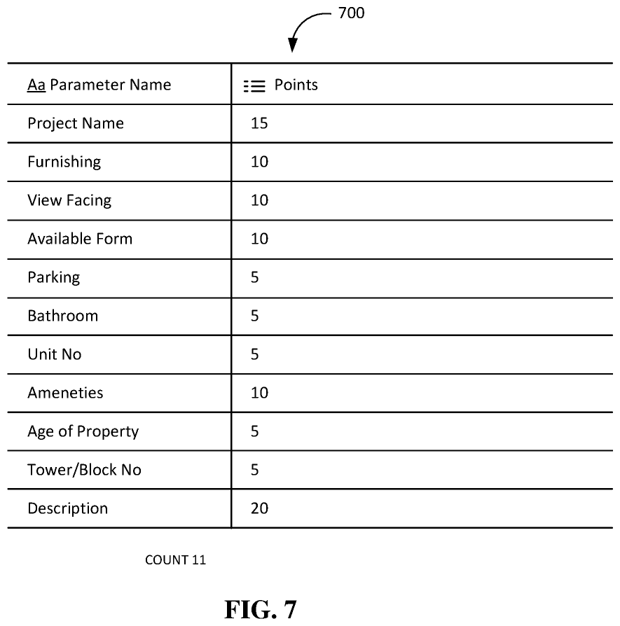

FIG. 7 is a tabular representation 700 illustrating listing completeness score, in accordance with some embodiments.

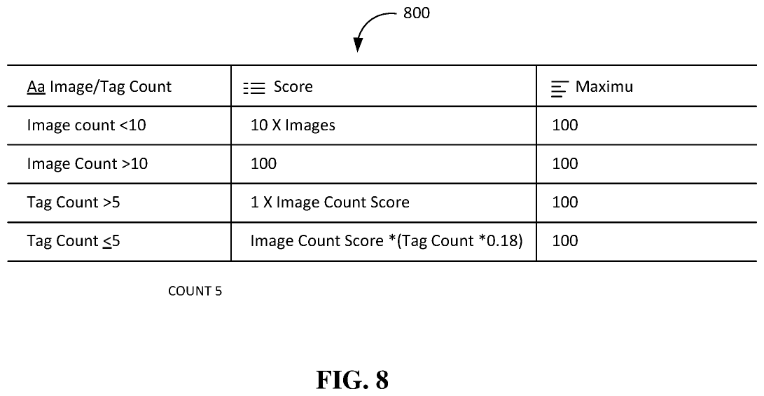

FIG. 8 is a tabular representation 800 illustrating factors for image quantity and tag score, in accordance with some embodiments.

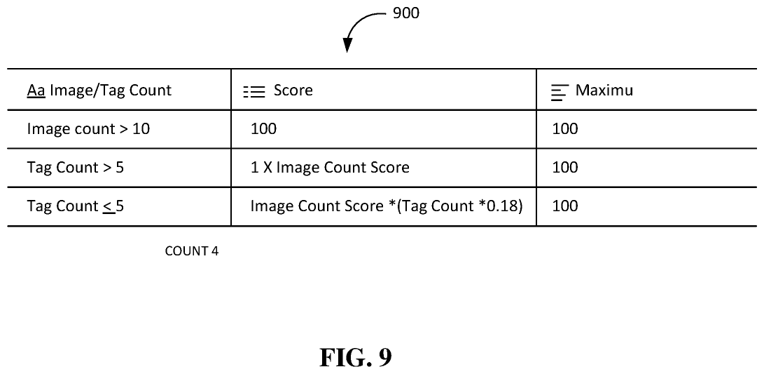

FIG. 9 is a tabular representation 900 illustrating factors for image quantity and tag score, in accordance with some embodiments.

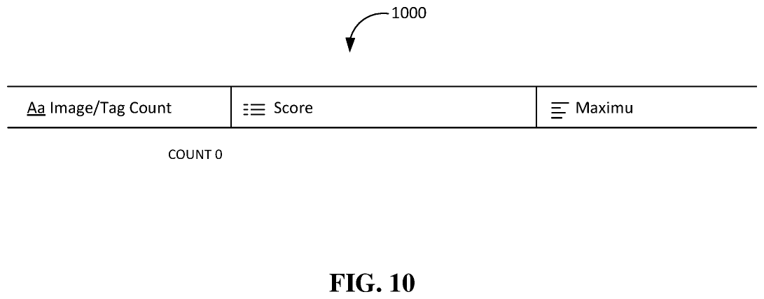

FIG. 10 is a tabular representation 1000 illustrating factors for image quantity and tag score, in accordance with some embodiments.

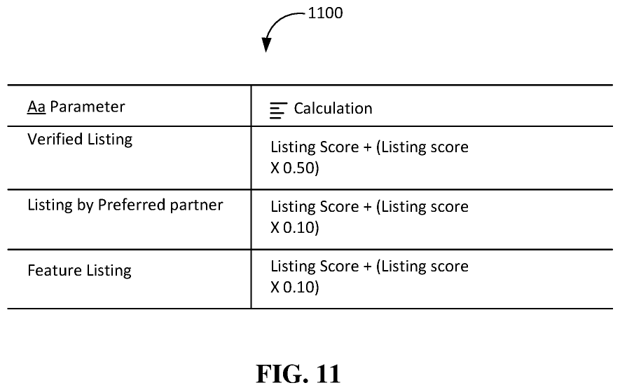

FIG. 11 is a tabular representation 1100 illustrating factors for boosting listing score, in accordance with some embodiments.

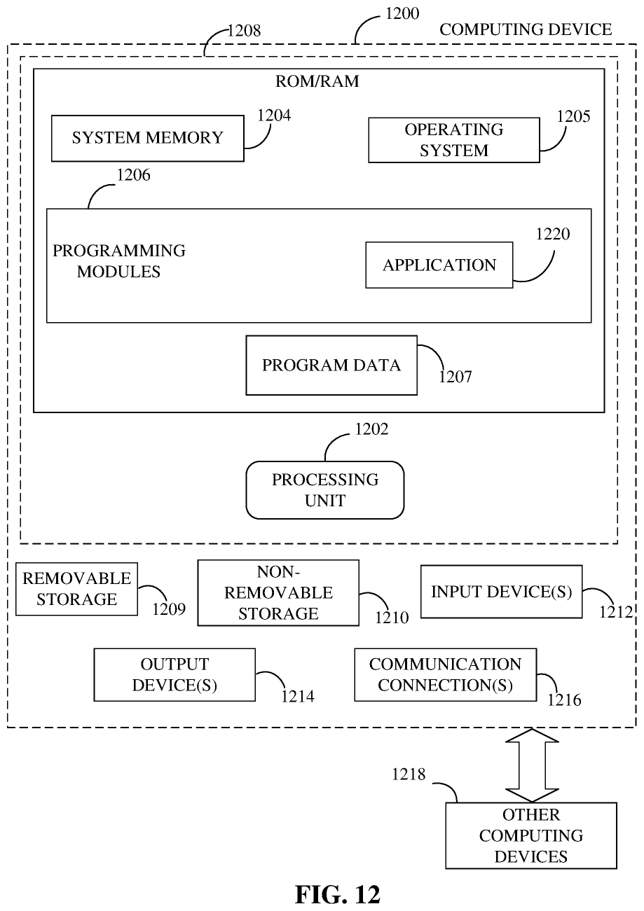

With reference to FIG. 12, a system consistent with an embodiment of the disclosure may include a computing device or cloud service, such as computing device 1200. In a basic configuration, computing device 1200 may include at least one processing unit 1202 and a system memory 1204. Depending on the configuration and type of computing device, system memory 1204 may comprise, but is not limited to, volatile (e.g. random-access memory (RAM)), non-volatile (e.g. read-only memory (ROM)), flash memory, or any combination. System memory 1204 may include operating system 1205, one or more programming modules 1206, and may include a program data 1207. Operating system 1205, for example, may be suitable for controlling computing device 1200's operation. In one embodiment, programming modules 1206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 12 by those components within a dashed line 1208.

Computing device 1200 may have additional features or functionality. For example, computing device 1200 may also include additional data storage devices (removable and/or non-removable) such as, for example, magnetic disks, optical disks, or tape. Such additional storage is illustrated in FIG. 12 by a removable storage 1209 and a non-removable storage 1210. Computer storage media may include volatile and non-volatile, removable and non-removable media implemented in any method or technology for storage of information, such as computer-readable instructions, data structures, program modules, or other data. System memory 1204, removable storage 1209, and non-removable storage 1210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1200. Any such computer storage media may be part of device 1200. Computing device 1200 may also have input device(s) 1212 such as a keyboard, a mouse, a pen, a sound input device, a touch input device, a location sensor, a camera, a biometric sensor, etc. Output device(s) 1214 such as a display, speakers, a printer, etc. may also be included. The aforementioned devices are examples and others may be used.

Computing device 1200 may also contain a communication connection 1216 that may allow device 1200 to communicate with other computing devices 1218, such as over a network in a distributed computing environment, for example, an intranet or the Internet. Communication connection 1216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1204, including operating system 1205. While executing on processing unit 1202, programming modules 1206 (e.g., application 1220 such as a media player) may perform processes including, for example, one or more stages of methods, algorithms, systems, applications, servers, databases as described above. The aforementioned process is an example, and processing unit 1202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

The following is claimed:

1. A method for facilitating improving sales associated with real estate, the method comprising:
receiving, using a communication device, one or more sale data associated with one or more sale sessions between one or more clients and one or more agents for conducting sales associated with one or more real estate from at least one first device;
analyzing, using a processing device, the one or more sale data using at least one machine learning model;
determining, using the processing device, one or more sale characteristics associated with the sales of the one or more real estate based on the analyzing of the one or more sale data;
determining, using the processing device, one or more behaviors of the one or more clients corresponding to the one or more sale characteristics based on the analyzing of the one or more sale data;
determining, using the processing device, a correlation between the one or more sale characteristics and the one or more behaviors corresponding to the one or more sale characteristics;
generating, using the processing device, at least one recommendation based on the correlation between the one or more sale characteristics and the one or more behaviors;
transmitting, using the communication device, the at least one recommendation to at least one device associated with at least one of at least one manager, the one or more agents, and the one or more clients; and
storing, using a storage device, the one or more sale data and the at least one recommendation.

2. The method of claim 1, wherein the one or more sale data comprises one or more transaction data associated with one or more transactions of the one or more real estate, wherein the analyzing of the one or more sale data comprises analyzing the one or more transaction data, wherein the one or more sale characteristics comprises one or more transaction characteristics of the one or more transactions, wherein the determining of the one or more sale characteristics comprises determining the one or more transaction characteristics, wherein the one or more behaviors comprises one or more transaction results of the one or more transactions, wherein the determining of the one or more behaviors comprises determining the one or more transaction results of the one or more transactions corresponding to the one or more transactions characteristics, wherein the determining of the correlation between the one or more sale characteristics and the one or more behaviors comprises determining the correlation between the one or more transaction characteristics and the one or more transaction results, wherein the generating of the at least one recommendation is further based on the correlation between the one or more transaction characteristics and the one or more transaction results.

3. The method of claim 1, wherein the one or more sale data comprises one or more sale pitches delivered by the one or more agents in the one or more sale sessions, wherein the analyzing of the one or more sale data comprises analyzing the one or more sale pitches, wherein the one or more sale characteristics comprises one or more agent characteristics of the one or more agents, wherein the determining of the one or more sale characteristics comprises determining the one or more agent characteristics associated with the one or more agents, wherein the determining of the correlation between the one or more sale characteristics and the one or more behaviors comprises determining the correlation between the one or more agent characteristics and the one or more behaviors, wherein the generating of the at least one recommendation is further based on the correlation between the one or more agent characteristics and the one or more behaviors, wherein the generating of the at least one recommendation comprises generating the at least one recommendation in real-time during the one or more sale sessions.

4. The method of claim 3, wherein the one or more sale data comprises one or more responses provided by the one or more clients corresponding to the one or more sale pitches in the one or more sale sessions, wherein the analyzing of the one or more sale data comprises analyzing the one or more responses, wherein the one or more behaviors comprises one or more reactions of the one or more clients, wherein the determining of the one or more behaviors comprises determining the one or more reactions of the one or more clients corresponding to the one or more agent characteristics, wherein the determining of the correlation between the one or more agent characteristics and the one or more behaviors comprises determining the correlation between the one or more agent characteristics and the one or more reactions, wherein the generating of the at least one recommendation is further based on the correlation between the one or more agent characteristics and the one or more reactions.

5. The method of claim 3, wherein the one or more sale pitches comprises at least one of one or more agent voices, one or more agent videos, and one or more agent movements of the one or more agents, wherein the analyzing of the one or more sale pitches comprises performing at least one of a voice analysis, a video analysis, and a motion analysis of at least one of the one or more agent voices, the one or more agent videos, and the one or more agent movements, wherein the determining of the one or more agent characteristics is further based on the performing of at least one of the voice analysis, the video analysis, and the motion analysis.

6. The method of claim 5, wherein the one or more agent characteristics comprises one or more appearances of the one or more agents, wherein the determining of the one or more agent characteristics comprises determining the one or more appearances of the one or more agents, wherein the determining of the one or more appearances are further based on the performing of the video analysis.

7. The method of claim 5 further comprising converting, using the processing device, the one or more agent voices into one or more agent speeches using at least one natural language processing model based on the performing of the voice analysis of the one or more agent voices, wherein the one or more agent characteristics comprises one or more keywords present in the one or more agent speeches, wherein the determining of the one or more agent characteristics comprises determining the one or more keywords present in the one or more agent speeches, wherein the determining of the one or more keywords is further based on the converting of the one or more agent voices into the one or more agent speeches.

8. The method of claim 7, wherein the one or more agent characteristics comprises one or more speech characteristics of the one or more agent speeches, wherein the determining of the one or more agent characteristics comprises determining the one or more speech characteristics of the one or more agent speeches, wherein the determining of the one or more speech characteristics is further based on the converting of the one or more agent voices into the one or more agent speeches.

9. The method of claim 1, wherein the one or more sale characteristics comprises one or more session characteristics associated with the one or more sale sessions, wherein the determining of the one or more sale characteristics comprises determining the one or more session characteristics associated with the one or more sale sessions, wherein the determining of the correlation between the one or more sale characteristics and the one or more behaviors comprises determining the correlation between the one or more session characteristics and the one or more behaviors, wherein the generating of the at least one recommendation is further based on the correlation between the one or more session characteristics and the one or more behaviors.

10. The method of claim 1 further comprising:
retrieving, using the storage device, one or more feedbacks provided by the one or more clients after the one or more sale sessions; and
analyzing, using the processing device, the one or more feedbacks, wherein the determining of the one or more behaviors of the one or more clients are further based on the analyzing of the one or more feedbacks.

11. A system for facilitating improving sales associated with real estate, the system comprising:
a communication device configured for:
receiving one or more sale data associated with one or more sale sessions between one or more clients and one or more agents for conducting sales associated with one or more real estate from at least one first device; and
transmitting at least one recommendation to at least one device associated with at least one of at least one manager, the one or more agents, and the one or more clients;
a processing device communicatively coupled with the communication device, wherein the processing device is configured for:
analyzing the one or more sale data using at least one machine learning model;
determining one or more sale characteristics associated with the sales of the one or more real estate based on the analyzing of the one or more sale data;
determining one or more behaviors of the one or more clients corresponding to the one or more sale characteristics based on the analyzing of the one or more sale data;
determining a correlation between the one or more sale characteristics and the one or more behaviors corresponding to the one or more sale characteristics; and
generating the at least one recommendation based on the correlation between the one or more sale characteristics and the one or more behaviors; and
a storage device communicatively coupled with the processing device, wherein the storage device is configured for storing the one or more sale data and the at least one recommendation.

12. The system of claim 11, wherein the one or more sale data comprises one or more transaction data associated with one or more transactions of the one or more real estate, wherein the analyzing of the one or more sale data comprises analyzing the one or more transaction data, wherein the one or more sale characteristics comprises one or more transaction characteristics of the one or more transactions, wherein the determining of the one or more sale characteristics comprises determining the one or more transaction characteristics, wherein the one or more behaviors comprises one or more transaction results of the one or more transactions, wherein the determining of the one or more behaviors comprises determining the one or more transaction results of the one or more transactions corresponding to the one or more transactions characteristics, wherein the determining of the correlation between the one or more sale characteristics and the one or more behaviors comprises determining the correlation between the one or more transaction characteristics and the one or more transaction results, wherein the generating of the at least one recommendation is further based on the correlation between the one or more transaction characteristics and the one or more transaction results.

13. The system of claim 11, wherein the one or more sale data comprises one or more sale pitches delivered by the one or more agents in the one or more sale sessions, wherein the analyzing of the one or more sale data comprises analyzing the one or more sale pitches, wherein the one or more sale characteristics comprises one or more agent characteristics of the one or more agents, wherein the determining of the one or more sale characteristics comprises determining the one or more agent characteristics associated with the one or more agents, wherein the determining of the correlation between the one or more sale characteristics and the one or more behaviors comprises determining the correlation between the one or more agent characteristics and the one or more behaviors, wherein the generating of the at least one recommendation is further based on the correlation between the one or more agent characteristics and the one or more behaviors, wherein the generating of the at least one recommendation comprises generating the at least one recommendation in real-time during the one or more sale sessions.

14. The system of claim 13, wherein the one or more sale data comprises one or more responses provided by the one or more clients corresponding to the one or more sale pitches in the one or more sale sessions, wherein the analyzing of the one or more sale data comprises analyzing the one or more responses, wherein the one or more behaviors comprises one or more reactions of the one or more clients, wherein the determining of the one or more behaviors comprises determining the one or more reactions of the one or more clients corresponding to the one or more agent characteristics, wherein the determining of the correlation between the one or more agent characteristics and the one or more behaviors comprises determining the correlation between the one or more agent characteristics and the one or more reactions, wherein the generating of the at least one recommendation is further based on the correlation between the one or more agent characteristics and the one or more reactions.

15. The system of claim 13, wherein the one or more sale pitches comprises at least one of one or more agent voices, one or more agent videos, and one or more agent movements of the one or more agents, wherein the analyzing of the one or more sale pitches comprises performing at least one of a voice analysis, a video analysis, and a motion analysis of at least one of the one or more agent voices, the one or more agent videos, and the one or more agent movements, wherein the determining of the one or more agent characteristics is further based on the performing of at least one of the voice analysis, the video analysis, and the motion analysis.

16. The system of claim 15, wherein the one or more agent characteristics comprises one or more appearances of the one or more agents, wherein the determining of the one or more agent characteristics comprises determining the one or more appearances of the one or more agents, wherein the determining of the one or more appearances are further based on the performing of the video analysis.

17. The system of claim 15, wherein the processing device further configured for converting the one or more agent voices into one or more agent speeches using at least one natural language processing model based on the performing of the voice analysis of the one or more agent voices, wherein the one or more agent characteristics comprises one or more keywords present in the one or more agent speeches, wherein the determining of the one or more agent characteristics comprises determining the one or more keywords present in the one or more agent speeches, wherein the determining of the one or more keywords is further based on the converting of the one or more agent voices into the one or more agent speeches.

18. The system of claim 17, wherein the one or more agent characteristics comprises one or more speech characteristics of the one or more agent speeches, wherein the determining of the one or more agent characteristics comprises determining the one or more speech characteristics of the one or more agent speeches, wherein the determining of the one or more speech characteristics is further based on the converting of the one or more agent voices into the one or more agent speeches.

19. The system of claim 11, wherein the one or more sale characteristics comprises one or more session characteristics associated with the one or more sale sessions, wherein the determining of the one or more sale characteristics comprises determining the one or more session characteristics associated with the one or more sale sessions, wherein the determining of the correlation between the one or more sale characteristics and the one or more behaviors comprises determining the correlation between the one or more session characteristics and the one or more behaviors, wherein the generating of the at least one recommendation is further based on the correlation between the one or more session characteristics and the one or more behaviors.

20. The system of claim 11, wherein the storage device is further configured for retrieving one or more feedbacks provided by the one or more clients after the one or more sale sessions, wherein the processing device is further configured for analyzing the one or more feedbacks, wherein the determining of the one or more behaviors of the one or more clients are further based on the analyzing of the one or more feedbacks.
